(19) United States
(12) Patent Application Publication
(10) Pub. No.: US 2020/0278706 A1
(43) Pub. Date: Sep. 3, 2020

(54) METERING VALVE AND JET PUMP UNIT FOR CONTROLLING A GASEOUS MEDIUM

(71) Applicant: Robert Bosch GmbH, Stuttgart (DE)

(72) Inventor: Hans-Christoph Magel, Reutlingen (DE)

(21) Appl. No.: 16/765,200

(22) PCT Filed: Sep. 24, 2018
(86) PCT No.: PCT/EP2018/075790

§ 371 Date: May 19, 2020

(30) Foreign Application Priority Data
Nov. 21, 2017 (DE) 10 2017 220 798.1

(51) Int. Cl. G05D 16/20; F16K 31/06; H01M 8/04089; B05B 1/00; F04F 5/46; H01M 8/04082; F04F 5/16

(52) U.S. Cl. CPC G05D 16/2022; F16K 31/0655; H01M 8/04089; F04F 5/16; F04F 5/46; H01M 8/04201; B05B 1/005

(57) ABSTRACT

The invention relates to a metering valve (1) for controlling a gaseous medium, particularly hydrogen, comprising a valve housing (2), wherein an interior space (3) is formed in said valve housing (2). A movable closing element (10) is arranged in the interior space (3) along a longindinal axis (40) of the metering valve (1), and said element interacts with a valve seat (19) in order to open or close off an opening cross-section of an inflow region (28) into a through channel (18). Furthermore, the metering valve (1) comprisies a nozzle (15) in which the through channel (18) is formed and on which at least one sealing element (54) is arranged, wherein the sealing element (54) is designed to seal a gap (56) in an opening in which said nozzle (15) is received.

### BACKGROUND OF THE INVENTION

The invention relates to a metering valve and jet pump unit for controlling a gaseous medium, in particular hydrogen, for example for use in vehicles with a fuel cell drive.

DE 10 2010 043 618 A1 describes a metering valve and jet pump unit for controlling a gaseous medium, in particular hydrogen, wherein the metering valve comprises a valve housing, an ejector unit, an actuator, and a closing element. A through opening, which can be released from or sealed against a valve seat by the closing element, is formed in the valve housing. The ejector unit comprises an inflow region to which a first pressurized gaseous medium is fed, an intake region at which a second medium is present, and a mixing tube region from which a mixture of the first and second gaseous medium emerges. The through opening is arranged between the inflow region and the intake region of the ejector unit.

Purging actions in an anode path of a fuel cell arrangement can be optimized by a combination of a metering valve and a jet pump. This can, however, result in a reduction in the sealing action of the metering valve and in leakage from the components involved.

### SUMMARY OF THE INVENTION

A reduction in sealing and leakage and hence optimal functioning of the metering valve and the jet pump in the fuel cell arrangement can be achieved by an improved design of the combination of metering valve and jet pump.

The metering valve according to the invention and the jet pump unit for controlling a gaseous medium, in particular hydrogen, has the advantage that, owing to the optimized integration of a metering valve into a jet pump unit, the tolerances at the valve seat are improved and consequently the sealing action inside the metering valve increased.

For this purpose, the metering valve for controlling a gaseous medium, in particular hydrogen, has a valve housing in which an interior space is formed. A closing element which can be moved along a longitudinal axis of the metering valve and interacts with a valve seat in order to open or close an opening cross-section of an inflow region into a passage duct is arranged in the interior space. The metering valve furthermore has a nozzle in which the passage duct is formed, wherein at least one sealing element is arranged on the outer side of the nozzle and is designed for the purpose of sealing a gap in an opening which receives the nozzle.

The jet pump unit furthermore comprises the metering valve according to the invention, a jet pump housing, a mixing tube region, an intake duct, and an outflow region. The jet pump housing here comprises the valve housing of the metering valve and a pump housing. The longitudinal axis of the metering valve is identical to a longitudinal axis of the jet pump unit.

The pump housing advantageously has a through bore which has a stepped design at least in some portions, wherein the nozzle of the metering valve is arranged on a first step formed on the pump housing, coaxially inside the pump housing upstream from the mixing tube region, and is received in an opening of the pump housing, wherein the at least one sealing element seals a gap between the nozzle and the pump housing. The through bore furthermore advantageously has a conical design at least in some portions, wherein an outflow duct of the jet pump unit is formed radially with respect to the longitudinal axis of the jet pump unit in the pump housing in the conical region of the through bore. The inflow duct of the metering valve is advantageously formed radially with respect to the longitudinal axis of the jet pump unit at least partially in the pump housing, wherein the valve housing is arranged with a step on the pump housing and is rigidly connected thereto, preferably by means of a screw element. The inflow region of the metering valve is advantageously arranged in the through bore.

Owing to the integration of the nozzle into the metering valve, it is possible to guide the flow of the gaseous medium downstream from the valve seat directly into the jet pump unit. An optimized design of the metering valve and the pump housing of the jet pump unit can be obtained as a result. The connection point between the metering valve and the nozzle is furthermore arranged in the pump housing of the jet pump unit, wherein the nozzle is integrated into the pump housing at the first step of the pump housing and is sealed with respect to the pump housing by the sealing element such that leakage in the direction of the intake region is minimized at the connection point between the metering valve and the nozzle.

In a first advantageous development of the invention it is provided that the nozzle comprises a pot-shaped region, wherein the at least one sealing element is arranged in the pot-shaped region. The pot-shaped region furthermore has a pot base on which the valve seat is formed. The valve housing advantageously has a protuberant end by means of which the valve housing is accommodated in the pot-shaped region of the nozzle, wherein the protuberant end in the inflow region has a surface which bears against a complementary surface formed on the nozzle. The nozzle can thus be connected to the valve housing in a structurally simple fashion, wherein it is not necessary for a seal to be guaranteed because the metering valve is sealed with respect to the pump housing by means of the sealing element.

In a further embodiment of the invention, it is advantageously provided that an adjusting element is arranged between the valve housing and the nozzle. Variable adjustment of the axial stroke of the closing element is thus achieved.

In an advantageous development it is provided that the valve seat is designed as a flat seat and an elastic sealing element is arranged between the valve seat and the closing element. By virtue of the use of a flat valve seat in combination with an elastic sealing element for sealing on the valve seat, the sealing of the metering valve can be ensured simply and without any large structural changes such that, for example, no hydrogen can escape from the metering valve.

In a further embodiment of the invention, it is advantageously provided that the metering valve comprises an electromagnet with an internal pole, wherein the internal pole and the valve housing are actively connected to each other via a magnetic throttle point. Owing to the one-part design of the internal pole and the valve housing and in combination with the connection point between the valve housing and the nozzle, the tolerances at the valve seat can be minimized and overall the sealing action of the metering valve improved.

In an advantageous development, the closing element is actively connected to a solenoid armature device, wherein the internal pole has a first guide section and a second guide section and wherein second bearing bushes are arranged on the second guide section, on which second bearing bushes the solenoid armature device is guided with a piston-shaped section. The piston-shaped section is advantageously manufactured from a material with a high mechanical strength. Radial tilting of the solenoid armature device is consequently minimized and the wear on the solenoid armature is also reduced when guided on the piston-shaped section. The latter can furthermore then be adapted to the mechanical circumstances such as, for example, the choice of a material with a high mechanical strength.

The jet pump unit described is preferably suited in a fuel cell arrangement for controlling the supply of hydrogen to an anode region of a fuel cell. Advantages are the low pressure fluctuations in the anode path and quiet operation.

### BRIEF DESCRIPTION OF THE DRAWINGS

Exemplary embodiments of a metering valve according to the invention and a jet pump unit for controlling the supply of gas, in particular hydrogen, to a fuel cell are shown in the drawings, in which:

FIG. 1 shows an exemplary embodiment of a metering valve according to the invention with a nozzle in a longitudinal cross-section,

FIG. 2 shows an exemplary embodiment of a jet pump unit according to the invention with the metering valve shown in FIG. 1 in a longitudinal cross-section.

Components with the same function have been designated with the same reference numerals.

### DETAILED DESCRIPTION

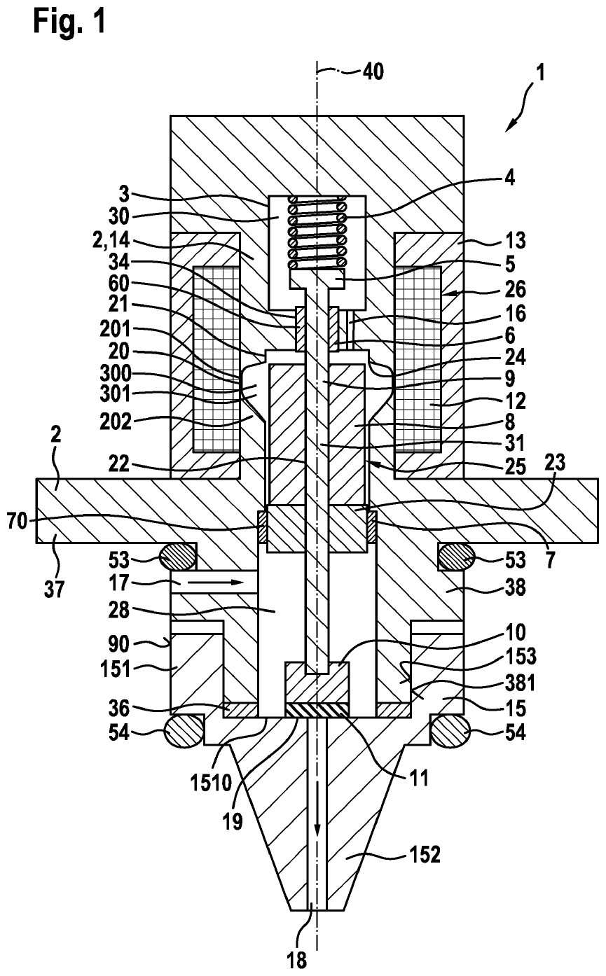

FIG. 1 shows a first exemplary embodiment of a metering valve 1 according to the invention in a longitudinal cross-section. The metering valve 1 has a valve housing 2 with an internal space 3. An electromagnet 26, which comprises a solenoid 12, an internal pole 14, and an external pole 13, is arranged in the internal space 3.

A solenoid armature device 25 which can move with a stroke movement is furthermore arranged in the internal space 3. The solenoid armature device 25 comprises a solenoid armature 8 and a connection element 9 which is accommodated in a recess 22 of the solenoid armature 8 and is hence rigidly connected to the solenoid armature 8, for example by a weld seam or by crimping. The solenoid armature 8 takes the form of a plunger and is accommodated in the internal pole 14. The internal pole 14 has a recess 21 with a recess edge 24 into which the solenoid armature 8 is inserted during its stroke movement.

First bearing bushes 60, in which the connection element 9 is accommodated and guided on a first guide section 6 of the internal pole 14, are arranged on the internal pole 14. Second bearing bushes 70, in which a piston-shaped section 23 of the connection element 9 is accommodated and guided in a second guide section 7, are furthermore arranged on the valve housing 2. The piston-shaped section 23 of the connection element 9 is here manufactured from a material with a high mechanical strength.

The metering valve 1 furthermore comprises a nozzle 15 which has a pot-shaped region 151 with a pot base 1510 and a protuberance 152. The valve housing 2 is accommodated, with a protuberant end 38 remote from the electromagnet 26, in the pot-shaped region 151 of the nozzle 15, wherein the valve housing 2 bears with a surface 381 against a complementary surface 153 of the nozzle 15. An adjusting element 36 is arranged between the protuberant end 38 of the valve housing 2 and the nozzle 15. Furthermore, sealing elements 54 are arranged on an outer side 90 of the nozzle 15, and sealing elements 53 are arranged on the valve housing 2.

The connection element 9 is rigidly connected at one end to a closing element 10. The closing element 10 has an elastic sealing element 11 at its end remote from the connection element 9. The elastic sealing element 11 interacts with a valve seat 19 formed on the pot base 1510 of the nozzle 15 such that, when the elastic sealing element 11 bears against the valve seat 19, a passage duct 18 formed in the nozzle 15 is closed. The valve seat 19 is formed here as a flat seat.

In the internal pole 14, a spring space 30 is formed which forms a part of the internal space 3. In the spring space 30, a closing spring 4 is arranged which is supported between the internal pole 14 and a plate-shaped end 5 of the connection element 9. The closing spring 4 stresses the solenoid armature device 25 with a force in the direction of the valve seat 19.

The internal space 3 furthermore comprises a solenoid armature space 300 in which the solenoid armature 8 is arranged. The solenoid armature space 300 is connected to the spring space 30 via a connection duct 16. At its end facing the closing element 10, the solenoid armature 8 adjoins an inflow region 28 which can be filled with a gaseous medium, for example hydrogen, via an inflow duct 17 which is arranged radially with respect to a longitudinal axis 40 of the metering valve 1 and formed in the valve housing 2.

The valve housing 2 and the internal pole 14 are connected to each other magnetically and mechanically via a magnetic throttle point 20. They can advantageously be formed as a single piece. The magnetic throttle point 20 comprises a thin-walled cylindrical web 201 and a conical region 202, as a result of which an annular groove is formed in the solenoid armature space 300.

Functioning of the Metering Valve 1

When there is no current applied to the solenoid 12, the closing element 10 is pressed onto the valve seat 19 via the closing spring 4 such that the connection between the inflow region 28 and the passage duct 18 is interrupted and there is no flow of gas.

When current is applied to the solenoid 12, a magnetic force is generated on the solenoid 8 which acts counter to the closing force of the closing spring 4. This magnetic force is transmitted to the closing element 10 via the connection element 9 such that the closing force of the closing spring 4 is overcompensated and the closing element 10 lifts off from the valve seat 19 with the elastic sealing element 11. The flow of gas through the metering valve 1 is released.

The stroke of the closing element 10 can be adjusted via the magnitude of the current strength at the solenoid 12. The greater the current strength at the solenoid 12, the greater the stroke of the closing element 10 and the greater too the flow of gas in the metering valve 1 because the force of the closing spring 4 is dependent on the stroke. If the current strength at the solenoid 12 is reduced, the stroke of the closing element 10 is reduced too and the flow of gas is thus throttled.

If the supply of current to the solenoid 12 is interrupted, the magnetic force on the solenoid armature 8 is decreased such that the force on the closing element 10 by means of the connection element 9 is reduced. The closing element 10 moves in the direction of the passage duct 18 and forms a seal on the valve seat 19 by means of the elastic sealing element 11. The flow of gas in the metering valve 1 is interrupted.

The metering valve 1 according to the invention can be used, for example, in a fuel cell arrangement. Hydrogen can be fed from a tank by means of the metering valve 1 to an anode region of the fuel cell. Depending on the magnitude of the current strength at the solenoid 12 of the metering valve 1 by means of which the stroke of the closing element 10 is triggered, a flow cross-section at the passage duct 18 is thereby modified in such a way that appropriate adjustment of the gas flow fed to the fuel cell takes place continuously.

The metering valve 1 for controlling a gaseous medium thus has the advantage that the feed of the first gaseous medium and the metered addition of hydrogen to the anode region of the fuel cell by means of electronically controlled adaptation of the flow cross-section of the passage duct 18 with simultaneous regulation of the anode pressure can take place in a significantly more precise fashion. As a result, the operational safety and durability of the connected fuel cell are considerably improved because hydrogen is at all times fed in a superstoichiometric proportion. Related damage such as, for example, damage to a catalytic convertor arranged downstream, can additionally be prevented.

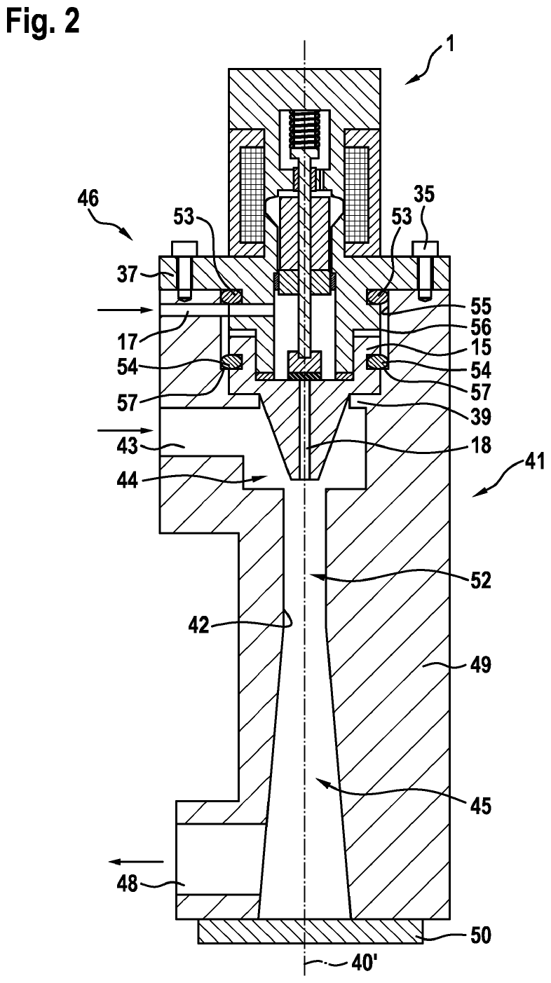

FIG. 2 shows a jet pump unit 46 with the metering valve 1 according to the invention in a longitudinal cross-section. The jet pump unit 46 has a jet pump housing 41 which comprises the valve housing 2 of the metering valve 1 and a pump housing 49. The jet pump unit 46 has a longitudinal axis 40′ which is identical to the longitudinal axis 40 of the metering valve 1.

In the pump housing 49, a through bore 42 which has a partially stepped design and a partially conical design is formed axially with respect to the longitudinal axis 40′, and an intake duct 43 and the inflow duct 17 of the metering valve 1 are formed radially with respect to the longitudinal axis 40′. An intake region 44, a mixing tube region 52, and an outflow region 45 are formed in the through bore 42. Portions of the metering valve 1 are accommodated coaxially in the pump housing 49. The valve housing 2 is here arranged with a step 37 on the pump housing 49 and is rigidly connected to the latter via a screw element 35. The valve housing 2 and the pump housing 49 are sealed with respect to each other by the sealing elements 53 of the valve housing 2 and the sealing elements 54 of the nozzle 15.

Furthermore, the nozzle 15 of the metering valve 1 bears against a step 39 formed on the pump housing 49 and is accommodated in an opening 55 of the pump housing 49. The nozzle 15 is sealed with respect to the first step 39 of the pump housing 49 by the sealing elements 54 on the nozzle 15 such that a gap 56 between the nozzle 15 and the pump housing 49 is sealed and no gaseous medium can pass via this gap 56 in the direction of the intake region 44. Gaseous medium from the inflow duct 17 thus passes only via the passage duct 18 in the direction of the intake region 44.

The pump housing 49 furthermore has a step 57 by means of which the nozzle 15 is centered radially in the pump housing 49 and is thus arranged coaxially in the pump housing 49 upstream from the mixing tube region 52. The positional tolerances of the metering valve 1, especially the nozzle 15, with respect to the pump housing 49 in conjunction with the step 39 can thus be minimized.

An outflow duct 48 is formed on that end region of the pump housing 49 remote from the metering valve 1, radially with respect to the longitudinal axis 40′ in the pump housing 49, wherein the through bore 42 is sealed by a cover 50 on that end region of the pump housing 49 remote from the metering valve 1.

Functioning of the Jet Pump Unit 46

When the valve seat 19 of the metering valve 1 is open or partially open, gaseous medium, in this case hydrogen, flows from the tank into the passage duct 18 in the nozzle 15 via the valve seat 19 out of the inflow duct 17 of the metering valve 1. After it emerges from the nozzle 15 and enters the through bore 42, in the intake region 44 this hydrogen meets a gaseous medium which has already been conveyed to the fuel cell but has not been consumed and has been returned to the jet pump unit 46 via the intake duct 43. The returned gaseous medium mainly comprises hydrogen but also steam and nitrogen. In the mixing tube region 52, a mass flow is drawn from the intake region 44 owing to momentum exchange of the gaseous medium and is conveyed in the direction of the outflow region 45 and hence in the direction of the anode region of the fuel cell. Depending on the geometry of the through bore 42 and the angle of insertion of the metering valve 1 and hence the nozzle 15, the gas flow conveyed to the fuel cell can be adjusted as required.

1. A metering valve (1) for controlling a gaseous medium, the metering valve comprising
a valve housing (2), wherein an interior space (3) is formed in the valve housing (2), with
closing element (10) which can be moved along a longitudinal axis (40) of the metering valve (1) and which interacts with a valve seat (19) in order to open or close an opening cross-section of an inflow region (28) into a passage duct (18), and
a nozzle (15) in which the passage duct (18) is formed, and at least one sealing element (54) is arranged on an outer side (90) of the nozzle (15), wherein the at least one sealing element (54) is configured to seal a gap (56) in an opening (55) which receives the nozzle (15).

2. The metering valve (1) for controlling a gaseous medium as claimed in claim 1, characterized in that the nozzle (15) comprises a pot-shaped region (151), wherein the at least one sealing element (54) is arranged in the pot-shaped region (151), and wherein the pot-shaped region (151) has a pot base (1510) on which the valve seat (19) is formed.

3. The metering valve (1) for controlling a gaseous medium as claimed in claim 2, characterized in that the valve housing (2) has a protuberant end (38) by means of which the valve housing (2) is accommodated in the pot-shaped region (151) of the nozzle (15), wherein the protuberant end (38) in the inflow region (28) has a surface (381) which bears against a complementary surface (153) formed on the nozzle (15).

4. The metering valve (1) for controlling a gaseous medium as claimed in claim 1, characterized in that an adjusting element (36) is arranged between the valve housing (2) and the nozzle (15).

5. The metering valve (1) for controlling a gaseous medium as claimed in claim 1, characterized in that the valve seat (19) is flat and an elastic sealing element (11) is arranged between the valve seat (19) and the closing element (10).

6. The metering valve (1) for controlling a gaseous medium as claimed in claim 1, characterized in that the metering valve (1) comprises an electromagnet (26) with an internal pole (14), wherein the internal pole (14) and the valve housing (2) are actively connected to each other via a magnetic throttle point (20).

7. The metering valve (1) for controlling a gaseous medium as claimed in claim 6, characterized in that the closing element (10) is actively connected to a solenoid armature device (25), wherein the internal pole (14) has a first guide section (6) and a second guide section (7) and wherein second bearing bushes (70) are arranged on the second guide section (7), on which second bearing bushes (70) the solenoid armature device (25) is guided with a piston-shaped section (23).

8. The metering valve (1) for controlling a gaseous medium as claimed in claim 7, characterized in that the piston-shaped section (23) is manufactured from a material with a high mechanical strength.

9. A jet pump unit (46) comprising a metering valve (1) as claimed in claim 1, with a jet pump housing (41), wherein the jet pump housing (41) comprises the valve housing (2) of the metering valve (1) and a pump housing (49), a mixing tube region (52), an intake duct (43), and an outflow region (45), wherein a longitudinal axis (40′) of the jet pump unit is identical to the longitudinal axis (40) of the metering valve (1).

10. The jet pump unit (46) as claimed in claim 9, characterized in that the pump housing (49) has a through bore (42) which has a stepped design at least in some portions, wherein the nozzle (15) of the metering valve (1) is arranged on a first step (39) formed on the pump housing (49), coaxially inside the jet pump unit (46) upstream from the mixing tube region (52), and is received in an opening (55) of the pump housing (49), wherein the at least one sealing element (54) seals a gap (56) between the nozzle (15) and the pump housing (49).

11. The jet pump unit (46) as claimed in claim 10, characterized in that the through bore (42) has a conical design at least in some portions, wherein an outflow duct (48) of the jet pump unit (46) is formed radially with respect to the longitudinal axis (40′) of the jet pump unit (46) in the pump housing (49) in the conical region of the through bore (42).

12. The jet pump unit (46) as claimed in claim 9, characterized in that the inflow duct (17) of the metering valve (1) is formed radially with respect to the longitudinal axis (40) of the jet pump unit (46) at least partially in the pump housing (49), wherein the valve housing (2) is arranged with a step (37) on the pump housing (49) and is rigidly connected thereto.

13. The jet pump unit (46) as claimed in claim 9, characterized in that the inflow region (28) of the metering valve (1) is arranged in the through bore (42).

14. A fuel cell arrangement with a jet pump unit (46) as claimed in claim 9, the jet pump unit being configured to control a supply of hydrogen to a fuel cell.

15. The jet pump unit (46) as claimed in claim 9, characterized in that the inflow duct (17) of the metering valve (1) is formed radially with respect to the longitudinal axis (40) of the jet pump unit (46) at least partially in the pump housing (49), wherein the valve housing (2) is arranged with a step (37) on the pump housing (49) and is rigidly connected thereto by a screw element (35).
